(19) United States
(12) Patent Application Publication
(10) Pub. No.: US 2014/0137413 A1
(43) Pub. Date: May 22, 2014

(54) FEEDING UTENSIL

(71) Applicants: Muhammad Imran Hanif, London (GB); Manit Wongchaiseree, Bangkok (TH)

(72) Inventors: Muhammad Imran Hanif, London (GB); Manit Wongchaiseree, Bangkok (TH)

(73) Assignee: Muhammad Imran HANIF, London (GB)

(21) Appl. No.: 14/115,947

(22) PCT Filed: May 4, 2012
(86) PCT No.: PCT/GB2012/050983

§ 371 Date: Nov. 6, 2013

(30) Foreign Application Priority Data
May 6, 2011 (GB) 1107572.8

(51) Int. Cl. A47G 21/02; B29C 45/14; B29C 65/00; A47G 21/04

(52) U.S. Cl. CPC A47G 21/023; A47G 21/04; B29C 45/14; B29C 65/00
USPC 30/123; 264/259; 156/60

(57) ABSTRACT

A feeding utensil (100) having a handle (102), a tool (104) end and an integrally formed flexible elongate strap (106) and the strap (106) having an engagement section (109) suitable for engaging with a portion of the handle (102), and methods of manufacture of such a feeding utensil (100).

The present invention relates to feeding utensils adapted to facilitate their use, in particular being suitable for users with limited manual control or dexterity.

### BACKGROUND

When training a young child in the use of feeding utensils, a commonly experienced problem is that the child lacks the manual dexterity and understanding necessary to clasp the handle of the feeding utensil over a prolonged period. Further, a frustrated infant may wilfully discard or throw away the feeding utensil. Similarly, children and adults with manual physical disabilities may also experience difficulties with grasping a feeding utensil. Accordingly the feeding utensil, such a spoon or other item of cutlery, may be released from the hand, allowing it to fall onto the floor, compromising the hygiene of the feeding utensil and distributing food from the utensil onto nearby clothing, furniture and the floor.

The designs of known devices intended for those with limited manual control or dexterity are unsatisfactory, as is illustrated by the following examples from the prior art.

U.S. Pat. No. 5,131,151 discloses an elastic cord with loops at each end, and friction controlled sliding beads retained between the loops. The handle of a separate, conventional feeding utensil is inserted into a one loop, and a corresponding bead is slid along the cord to constrict the loop around the utensil. The bead engages with the cord and is held in place by friction, in order to maintain the constriction of the loop. The child's wrist is inserted into the other loop, which is similarly constricted about the wrist by use of a further bead. The cord is of sufficient length so as to permit movement of the utensil for eating. Accordingly, if during feeding the child should release its grasp upon the feeding utensil, it will fall from the child's hand, but the length of cord will arrest the utensil's fall before it reaches the floor.

Disadvantageously, the cord of U.S. Pat. No. 5,131,151 does not retain the utensil in the hand of the child, and accordingly food held on the utensil when it is dropped will nonetheless fall into the surrounding area. Further, the cord does not assist the child with learning to hold feeding utensils, but in contrast will make it more difficult for the child to manoeuvre the utensil and may irritate the child, which will impede use of the utensil and the learning process. Further disadvantageously, to permit the full range of movement of the utensil would typically provide a length of slack strap between the two loops, which is susceptible to snagging on furniture and items within the child's place setting, particularly problematically risking snagging on drinking vessels. Fitting and removing the strap from the feeding utensil and from the child's wrist is fiddly. Further, the cord comprises multiple components, with significant consequences for manufacturing and assembly costs. Additionally, the cord is separable from the utensil, which increases the likelihood of the cord becoming lost when not in use. With repeated use, the frictional engagement between the sliding bead and the cord is vulnerable to wear, reducing effectiveness and usable lifetime of the cord. Further, the beads may be difficult to clean and may retain spilt food internally. Being small and flexible, the cord may be unsuitable for inclusion within a washing load of an automatic dishwasher, and may risk becoming entangled in moving parts of the dishwasher. Also, it is noted that in use the strap would be inclined to rotate around the handle such that the point of the pear-shaped loop (where the size of the loop is constricted by the bead) comes adjacent to the edge of a flat handled utensil, of the type common in infant feeding utensils, further inconveniencing the user.

GB2229130 discloses a separate spoon and strap, with which the spoon can be strapped to a user's hand. The strap comprises mating parts of a fabric hook-and-loop fastener at opposite ends.

Disadvantageously, the strap of GB2229130 cannot be used with conventional feeding utensils, and in contrast the strap is only usable with specially adapted feeding utensils that are provided with apertures at either end of the handle, and through which the strap is threaded. Fitting and removing the strap from the feeding utensil and from the child's wrist is fiddly, typically requiring the spoon and each end of the strap to be simultaneously held by the supervising person. Similarly, unstrapping the spoon from the user's hand is also fiddly and may result in the strap becoming separated from the spoon, and may even lead to the spoon being dropped. Further, in use, a central portion of the strap runs along the length of the handle between the apertures, and within the grip of the user, providing a source of discomfort to the user. Additionally, the hook-and-loop fastener of the strap is secured across the back of the user's hand, providing further discomfort to the user. Disadvantageously, it will be difficult to maintain the hygiene of the strap, due to the difficult of cleaning the hook-and-loop fasteners in order to remove ingrained food. Being small and flexible, the strap may be unsuitable for inclusion within a washing load of an automatic dishwasher, and may risk becoming entangled in moving parts of the dishwasher. Further, the provision of a separate dedicated strap and dedicated spoon has significant consequences for manufacturing and assembly costs. Additionally, the strap is separable from the spoon, which increases the likelihood of the cord becoming lost when not in use.

Accordingly, there remains a need in the art for an improved feeding utensil strap that seeks to address at least some of the disadvantages of the prior art.

### SUMMARY OF THE DISCLOSURE

According to a first aspect of the invention, there is provided a feeding utensil having a handle, a tool end and an integrally formed flexible elongate strap, and the strap having a fixed end, a free end and an engagement section suitable for engaging with a portion of the handle.

According to a second aspect of the invention, there is provided a method of manufacturing a feeding utensil having a handle, a tool end and a flexible elongate strap, and the strap having a free end and a fixed end and an engagement section suitable for engaging with a portion of the handle, comprising providing handle or a portion of the handle, and integrally forming at least the strap onto the handle or portion of the handle by an injection moulding process.

According to a third aspect of the invention, there is provided a method of manufacturing a feeding utensil having a handle, a tool end and a flexible elongate strap, and the strap having a free end and a fixed end and an engagement section suitable for engaging with a portion of the handle, comprising providing handle or a portion of the handle, and bonding at least the strap onto the handle.

The strap may be flexible across typical operating temperatures, including commonly occurring room temperatures and above body temperature, e.g. the strap remains flexible at least in the range 10 to 50° C. Advantageously, the flexibility enables comfortable use of the strap, across typical operating conditions.

The strap may be resiliently deformable under tensional and warping (torsional) forces, across typical operating temperatures. The strap may comprise elastic polymeric material. The handle may comprise a material that is relatively inflexible (compared with the strap). Advantageously, this provides a handle that can be firmly held whilst the flexible strap comfortably conforms around the hand of the user. The handle may comprise a rigid material. For example the rigid material may be a plastics material, such as high-density polyethylene (HDPE), and may include carbon nano-fibres.

The fixed end of the strap may be fixed to the handle proximate the tool end. Advantageously, this can enable more convenient fitting of the strap around the hand of a user, than in the case that the fixed end of the strap being fixed of the handle remote from the tool end.

The engagement section may be an aperture suitable for receiving a portion of the handle. Advantageously, a particularly secure fit to the user's hand may be achieved where the engagement section has an aperture suitable for receiving a portion of the handle. The aperture may be distensible. The aperture may be elongate. The direction of elongation of the aperture may be transverse to the direction of elongation of the strap. The direction of elongation of the aperture may be substantially perpendicular to the direction of elongation of the strap. The aperture may be selected from the group consisting of a straight slot, a curved slot, an oval, and a dumbbell shape.

The strap may have a plurality of apertures suitable for receiving a portion of the handle. The strap may comprise apertures of different sizes.

The strap may comprise a strip section and a connectable section having an aperture, and the strap has a narrow region between the connectable section and the strip section. The strap comprises a strip section and a connectable section comprising a plurality of apertures, and the connectable section of the strap has a narrow region between the adjacent apertures. The apertures may be between 10 and 16 mm long. The engagement section may be an aperture suitable for receiving a portion of the handle and the aperture may be between 2 and 6 mm wide.

The handle and strap may be provided with complementarily shaped features configured for mutual engagement. The complementarily shaped features may be parts of a press-stud arrangement. The complementarily shaped features may comprise, a forked end of the handle or a slot in the handle, and a narrow region of the strap configured to engage with the forked end of the handle or the slot in the handle.

The strap may comprise a strip section and a narrow fixed end section, the narrow fixed end section being between the strip section and the handle and/or tool end.

The strap may comprise a strip section and a connectable section, and the strip section and the connectable section may be of substantially equal width. The strap may comprise a strip section and a connectable section, and the connectable section may be wider than the strip section. The strip section may have a substantially uniform width. The strap may comprise a strip section and a connectable section, and the strip section may have a region between the ends of the strip section that is wider than the ends of the strip section.

The strip section may be substantially straight. The strip section may be curved.

The strap may comprise a strip section and a connectable section, and the connectable section may be of a greater thickness than the strip section. The strap may have a substantially uniform thickness.

A surface of the strap for contacting a user's hand may have a fabric covering. A surface of the strap for contacting a user's hand may have a friction enhancing profile.

The strap may be between 80 and 220 mm long. The strip may be between 10 and 30 mm wide. The strip may be between 1 and 4 mm thick. The engagement section may be adjacent the free end of the strap. The engagement section may be intermediate the free end and the fixed end of the strap. The feeding utensil may be selected from the group consisting of a knife, a fork and a spoon.

The handle may comprise a first material, and the strap and tool end may comprise a second material, wherein the second material is different from the first material. The handle and tool end may comprise a first material, and the strap may comprise a second material, wherein the second material is different from the first material. The handle may be provided with a recess in the first material, and the strap may be received into the recess.

### BRIEF DESCRIPTION OF THE DRAWINGS

Embodiments of the invention are further described hereinafter with reference to the accompanying drawings, in which:

FIGS. 1A and 1B show a feeding utensil having a strap with three apertures.

FIGS. 2A, 2B and 2C show designs of strap each having a single aperture.

FIGS. 3A and 3B show designs of strap each having two apertures.

FIGS. 4A and 4B show parts of a feeding utensil, including straps each having two apertures of different sizes.

FIGS. 5A, 5B and 5C show designs of straps having different thickness profiles.

FIG. 6 shows a strap having a wide connectable section.

FIG. 7 shows a strap having an elongate aperture that is oblique to the length of the strap.

FIG. 8 shows a curved strap.

FIG. 9A and 9B show a strap having a curved aperture.

FIG. 10 shows a strap having a broad mid-section.

FIG. 11 shows a strap having a friction enhancing profile.

FIG. 12 shows a part of a feeding utensil incorporating a press-stud arrangement.

FIGS. 13A, 13B and 13C show parts of feeding utensils in which the strap engages with the handle by passing through an aperture in the handle.

FIG. 14 shows part of a feeding utensil in which the strap engages with a forked end of the handle.

FIGS. 15A to 15E show a feeding utensil having a strap with three apertures and component parts of such a feeding utensil.

### DETAILED DESCRIPTION

In the described embodiments, like features have been identified with like numerals, albeit in some cases having one or more of: increments of integer multiples of 100; suffix letters and typographical marks (e.g. primes). For example, in different figures, 114, 114′, 114″, 214A, 214B and 214C have been used to indicate an aperture.

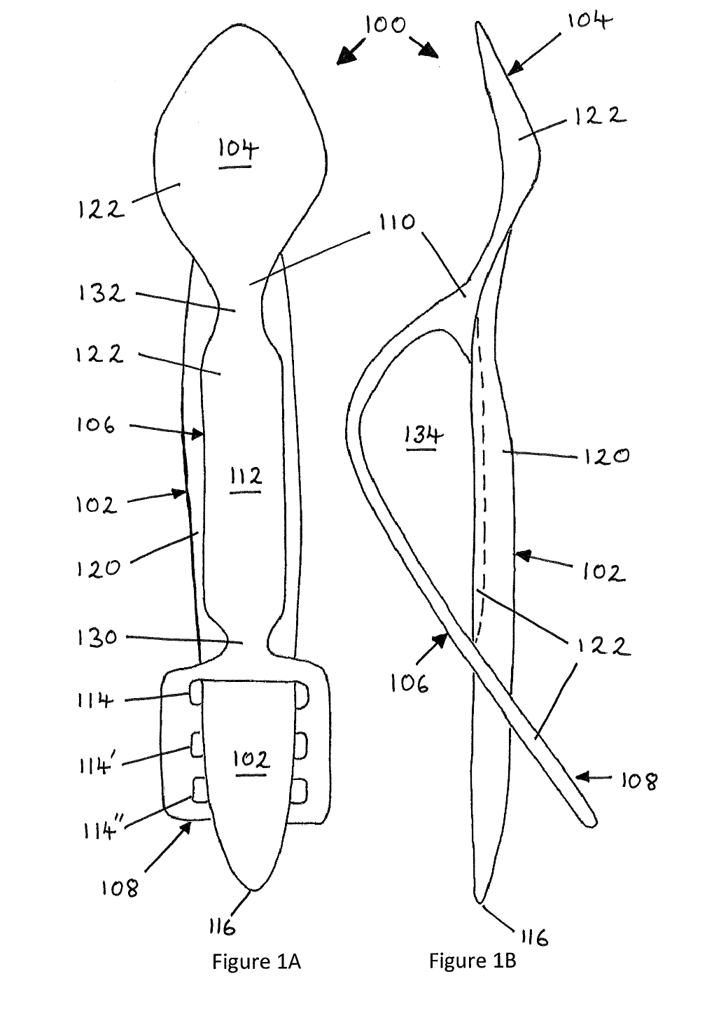

FIGS. 1A and 1B illustrate a feeding utensil according to a first embodiment. The feeding utensil 100 (e.g. a spoon) comprises a relatively rigid handle 102, a relatively flexible tool end 104 (i.e. the part of the feeding utensil designed for handling food, e.g. spoon bowl, fork tines, or knife blade) and a similarly flexible elongate strap 106. The strap 106 has a connectable section 108, a fixed end section 110 and a strip section 112 between the connectable section (engagement section) and the fixed end section. The connectable section 108 comprises a plurality of elongate apertures 114, 114′ and 114″.

In use: the handle 102 is placed into the palm of the user's hand (e.g. an infant's hand); the strap 106 is stretched around the back of the user's hand; the strap is stretched sufficiently that the end 116 of the handle passes through one of the apertures 114 of the strap; and the strap is released. Accordingly, once the aperture 114 has engaged with the handle 102, the strap 106 holds the handle against the palm of the user's hand, even if the user releases their grasp upon their handle.

The strap 106 is stretchable, forms a snug fit around the back of a user's hand, and presses the handle 102 against the palm of the hand. The firmness with which the strap 106 presses the handle 106 against the palm of the user's hand may be modified through adjusting the separation (measured along the handle) between the fixed end section 110 and the connectable section 108, e.g. by sliding the handle 102 further, or less far, through the aperture 114.

In the examples shown in FIG. 1A, the aperture 114 contacts the handle along the sides of the aperture. However, it will be appreciated that it is also possible that with alternative design of handle 102 or aperture 114, the aperture may contact the handle all the way around, or may contact the handle only at edge regions of the handle.

The strap is several times longer (L1) than it is wide (W1), when measured from the handle at the fixed end of the strap to the free end of the strap. In the embodiment illustrated in FIGS. 1A and 1B: the length (L1) of the strap is about 80 mm; the width (W1) of the strap is about 23 mm; the strap has a thickness (T) of about 2 mm, and a separation between the aperture 114 and the handle 106 of the feeding utensil 100 is a length of about 64 mm along the length of the strap. The apertures 114 to 114″ are elongate apertures, orientated perpendicular to the length of the strap 106, and have the shape of straight-sided slots with rounded ends, 13 mm long and 4 mm wide. Such a feeding utensil 100 is suitable for a six month old infant.

In the embodiment illustrated in FIGS. 1A and 1B, the feeding utensil 100 comprises two materials 120 and 122. The majority of the handle 102 consists of the first material 120. The strap 106 is formed from a thin strip of the second material 122. The tool end 104 (the bowl of a spoon) is formed from the second material 122, and is integrally formed with the strap 106. A region of the second material 122 also forms part of the handle 102, being inlaid into a recess in the first material. Alternatively, the second material 122 may be formed through holes in the first material.

The first material is a relatively rigid material, such as a high density plastics material, e.g. high density polyethylene, and may include carbon nano-fibres.

The second material is a resiliently deformable material. The second material may have a Youngs modulus of between 0.04 and 0.20 kg/mm², and preferably between 0.06 and 0.14 kg/mm². The second material may be an elastomeric polymer material, such as tear resistant silicone rubber, which is suitable for use in food applications. Other resiliently deformable second materials include elastic fabric, natural rubber, neoprene (polychloroprene), and foamed neoprene. The second material is soft to the touch.

The strap 106 and the handle 102 of the feeding utensil 100 are integrally formed. For example the feeding utensil 100 may be formed by injection moulding the second material 122 onto and/or around a blank formed of the first material 120.

The feeding utensil 100 is easy to wash to avoid the accumulation of food. Preferably the feeding utensil 100 is dishwasher-proof, and the integral formation of the strap 106 with the handle reduces the risk of the strap becoming entangled in the dishwasher mechanism.

The strap 106 of FIG. 1A has a narrow region 130 between the connectable section 108 and the strip section 112, and the fixed end section 110 comprises a further narrow region 132. The narrow regions 130 and 132 provide regions of enhanced flexibility to facilitate relative movement of the connectable section 108 and the strip section 112 of the strap 106. Removing part of the width of the strap 106 in the narrow regions 130 and 132 provides regions that more easily bend both in the plane of the strap and perpendicular to the plane of the strap, as well as providing regions that are more easily able to warp (twist), such that the strip may twist relative to the end sections.

Conveniently, the handle 102 and tool end 104 of the feeding utensil 100 may be shaped like a conventional infants feeding utensil, which typically has a handle having generally flat top and bottom surfaces that are several times wider than the thickness of the handle, to facilitate grasping by an infant who is training to hold feeding utensils and to feed independently. Commonly the handles of infants' feeding utensils have a constant width along the length of the handle or are tapered towards the handle end remote from the tool end.

The apertures 114 to 114″ of the strap 106 are advantageously the same size as, or smaller than, the width and/or thickness of the handle 102, such that tip 244 of the handle can be inserted through an aperture of the strap 200 by pushing and/or pulling by a carer (e.g. a parent or other supervising adult). The apertures 114 to 114″ are distensible, and stretch to grip the portion of the handle 102 that is received within the aperture with sufficient friction that they do not move during use of the feeding utensil 100 for feeding by a user (e.g. young child). Advantageously the level of friction between the aperture 114 of the strap 106 and the handle 102 is such that an infant cannot easily move the connectable section 108 of the strap from the position into which it has been located on the handle 102 by a carer, or displace the connectable section over the end of the handle to release the strap from the handle.

When the strap 106 is fitted to the handle 102, the narrow region 130 facilitates distension of the aperture 114 by stretching to accommodate the handle. When the aperture 114 is fitted to the handle 102, the narrow regions 130 and 132 bend preferentially to the strip section 112, providing a more convenient shape to the gap 134 that is described between the strap 106 and the handle 102 in use.

In an alternative method of attaching the feeding utensil 100 to a user's hand, the aperture 114 may be stretched over the end 116 of the handle 102 prior to insertion of the user's hand into the gap 134 that is described between the strap 106 and the handle 102. In this case, the enhanced flexibility of the narrow regions 130 and 132 facilitates insertion of a hand between the fitted strap 106 and the handle 102, as well as facilitating flexing of the strap 106 in use, thereby enhancing user comfort.

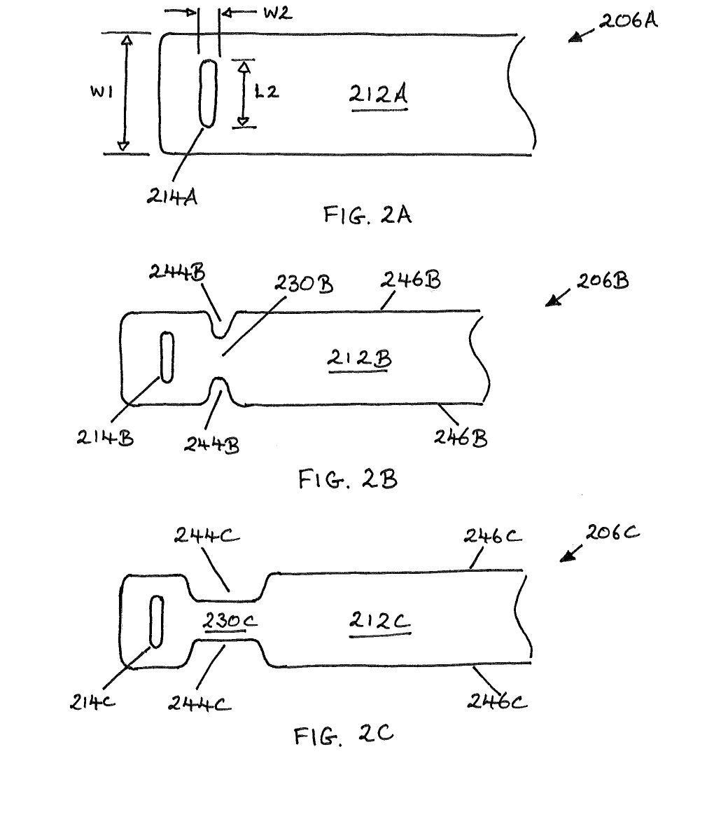

FIGS. 2A, 2B and 2C illustrate straps 206A, 206B and 206C having alternative connectable sections, each having a single aperture 214A, 214B and 214C. FIG. 2A illustrates a strap 206A without a narrow section between the strip section 212A and the aperture 214A. FIG. 2B illustrates a strap 206B that is similar to the strap 106 of FIGS. 1A and 1B, which has a narrow region 230B between the strip section 212B and the aperture 214B. The narrow region 230B may comprise V-shaped or U-shaped cut-away portions 244B in the sides 246B of the strap 206B. FIG. 2C illustrates a strap 206C that is similar to the strap 206B of FIG. 2B, but in which the narrow region 230B is longer than that of FIG. 2B, in this example having parallel-sided indented regions 244C. The longer narrow regions 244C may provide regions of even greater flexibility than the shorter narrow regions 244B of FIG. 2B.

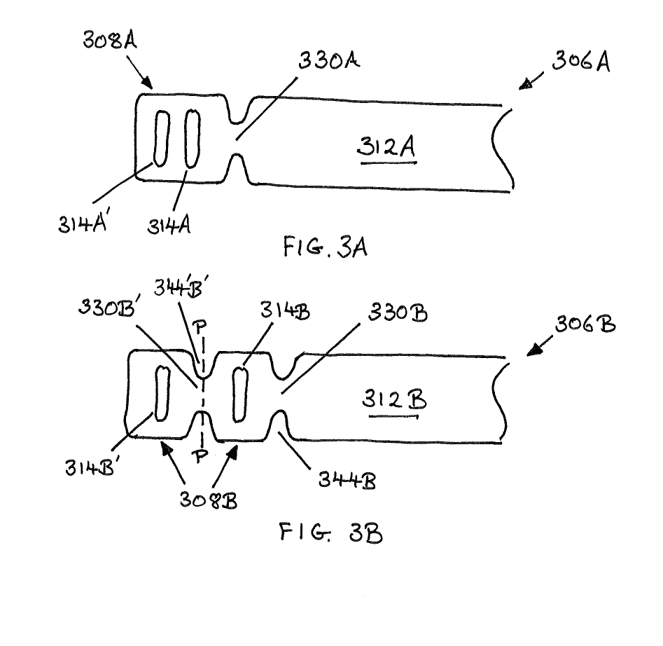

As is illustrated in FIG. 3A, the strap 306A may have two apertures 314A and 314A′ in the connectable section 308A. This provides a choice of size of the gap 134 that is described between the strap 106 and the handle 102, in use. Advantageously a strap 306A with a plurality of apertures 314A and 314A′ provides a feeding utensil that fits a wider range of sizes of hand. This may reduce manufacturing and retail costs by permitting the provision of only a single size of product suited to infants of different ages or who are being trained to feed independently at different ages. Further, advantageously, in the case that the feeding utensil is used by more than one user, this may provide additional versatility which may avoid the requirement for dedicated feeding utensils for different users.

As is illustrated in FIG. 3B, the strap 306B may be provided with a plurality of narrow regions 330B and 330B′. A first narrow region 330B is provided between the strip section 312B and the connectable section 308B, and a second narrow region 330B′ is provide within the connectable section 308B between the first and second apertures 314B and 314B′.

In the case that a plurality of apertures are provided in the strap, the strap may advantageously be trimmed to size, in the case that only a shorter aperture separation is required. Such trimming may avoid a longer end of the strap projecting beyond the opposite side of the handle from the strip section, which may distract or irritate the user during feeding, or which may catch in food or may catch against other items of the user's place setting. For example, in the case of the strap 306B, if only use of the aperture 314B is required, then the strap may be cut across at the position indicated by the lines P, such that the end of the strap having the aperture 314B′ is removed.

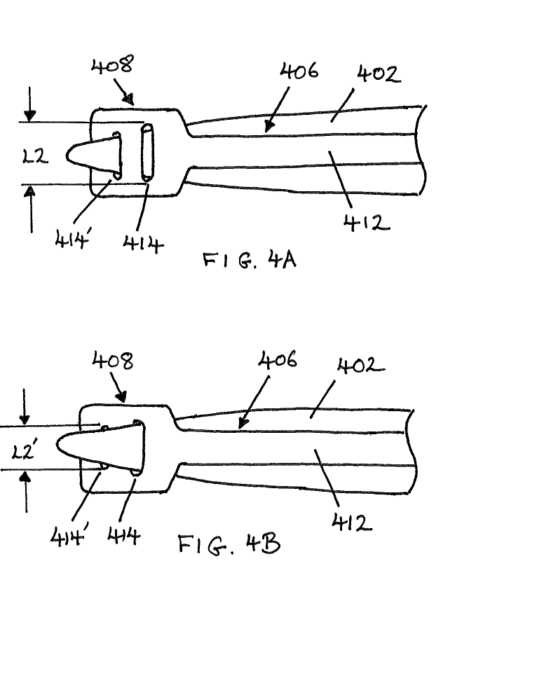

As is illustrated in FIGS. 4A and 4B, the strap 406 may have apertures 414 and 414′ of different sizes, which are shaped to receive parts of the handle 402 of corresponding widths. this many facilitate use of a single design by users with a range of hand sizes.

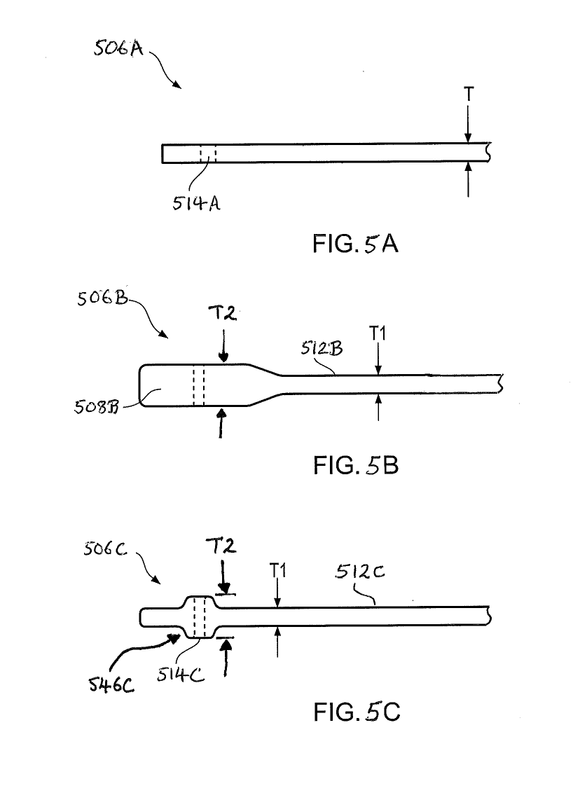

As is illustrated in FIG. 5A, the strap 506A may be of uniform thickness T. Alternatively, as is illustrated in FIG. 5B, the connectable section 508B of the strap 506B may be thicker than the strip section 512B. Advantageously, such a design provides regions of the material having greater strength around the apertures, which may be more resistant to tearing, thereby increasing usable product life, as well as increasing the grip between the strap and the handle.

In a further alternative, illustrated in FIG. 5C, the strap 516C may have a reinforced region 546C localised around the aperture 5140 (engagement section). The reinforced regions may conveniently be provided by a region of greater thickness T2 compared with the thickness T1 of the strip section 512C. Alternatively, reinforcement of the aperture might be provided by use of a different composition of the material around the aperture.

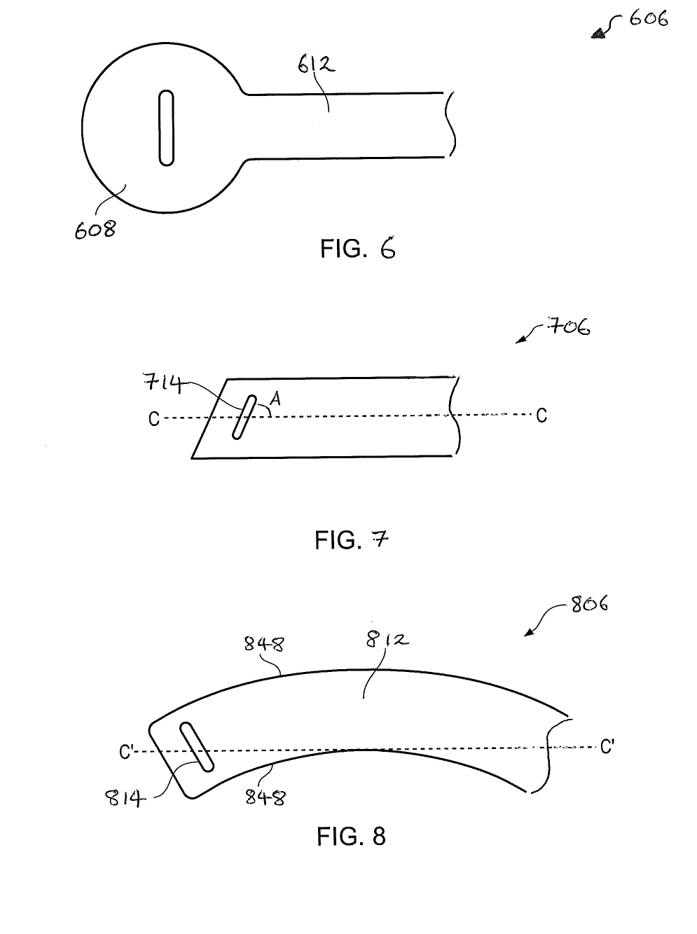

Greater grip between the strap 606 and a fitted utensil handle may also be provided by the connectable sections 608 being wider than the strip section 612, as shown in FIG. 6.

As is illustrated in FIG. 7, the transverse aperture 714 may be orientated with its length other than perpendicular to centre line C-C, which is described along the length of the strap 706. For example it may be orientated with an acute angle A of 80 degrees. In use, the inclination of the aperture away from the perpendicular may provide a gap between the strap and the handle that better fits a user's hand. In the case that the connectable section has a plurality of apertures, they may be provided at different angles to the length of the strap.

As with the strap 706 of FIG. 7, the strap 806 of FIG. 8 also has an aperture 814 that is not perpendicular to a line C′-C′ passing centrally through the aperture. Further, the strap 806 has curved sides 848 and 848, which may further enhance user comfort where the strip section 806′ passes across the back of the hand of the user.

The apertures illustrated are shown as parallel-sided slot-like apertures. However, other shapes of generally elongate aperture may be suitable for gripping a utensil handle, such as an oval aperture, a curved slot-like aperture or a dumbbell-shaped aperture.

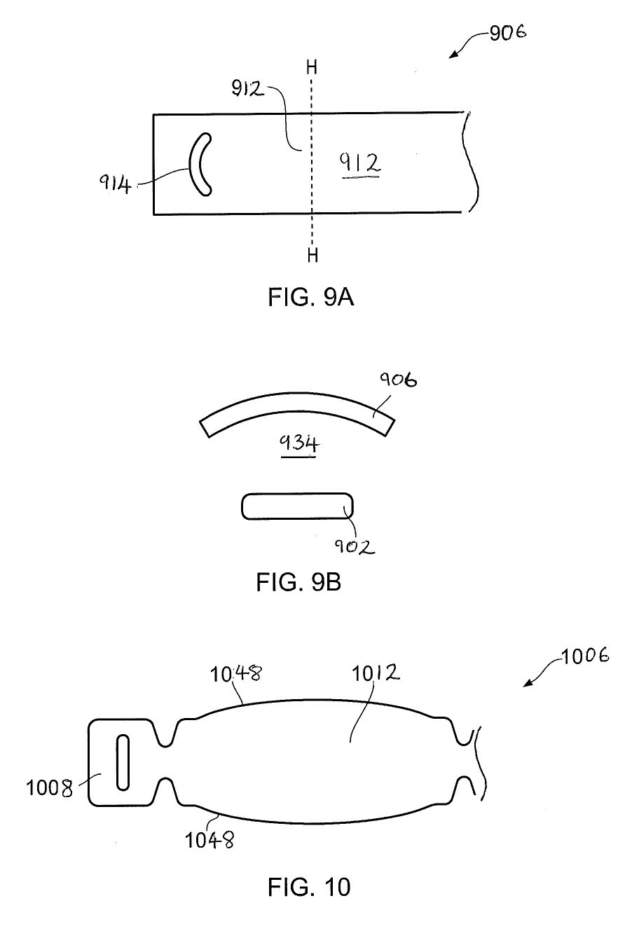

FIGS. 9A and 9B illustrates a strap 906 having a curved slot-like aperture 914. When fitted to a utensil handle 902, such a design may provide a lateral curvature (across the width, indicated by line H-H) of the strip section 912, such that the strip section is more comfortable to the user when the user's hand is in-situ within the gap 934 that is described between the strap 906 and the handle 942, as shown in FIG. 9B. Advantageously, an aperture shape that is not straight may further enhance the grip between the strap 900 and the handle 942.

FIG. 10 illustrates a strap 1006 in which the strip section 1006 has curved sides 1032 and 1034 and is broader in a central section than adjacent the end sections 1002 and 1004, which may further enhance user comfort.

The frictional contact between a contact surface 1150 of a strap 1106 and a user's hand may be enhanced by providing a profiled finish on at least the strip section, such as array of hemispherical projections 1152, as is illustrated in FIG. 11. Other profiled designs may also be used, or the enhanced frictional contact may be provided by use of a coating or a fabric finish.

The engagement section may be provided by an arrangement of complementarily shaped features of the strap and handle that are adapted for mutual engagement.

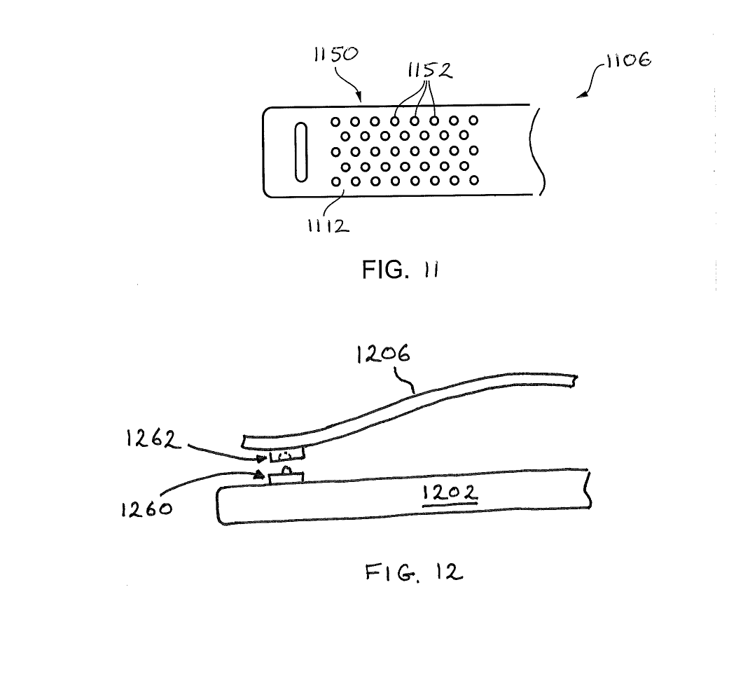

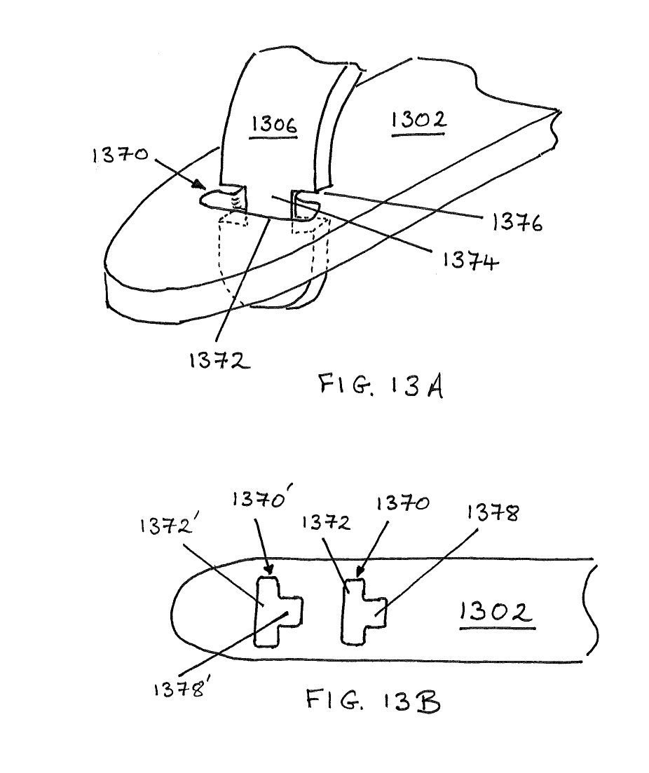

FIG. 12 illustrates a press-stud arrangement (pop-stud arrangement) in which male and female mating elements 1260 and 1262 are provided on the handle 1202 and strap 1206.

Conveniently, a plurality of mating elements may be provided on either or both of the handle or strap.

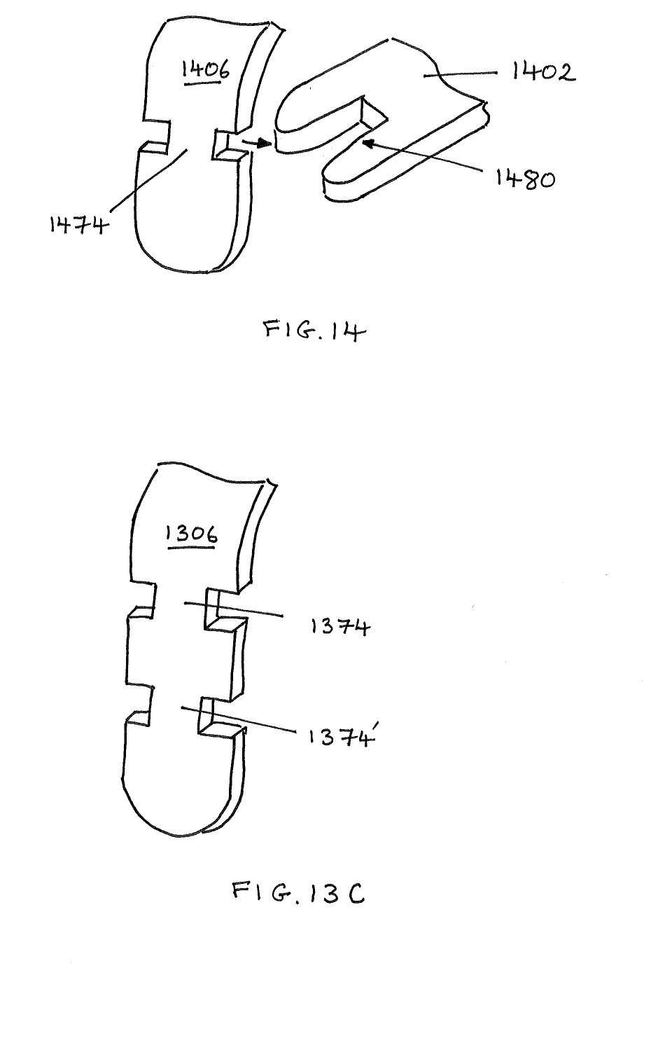

FIG. 13A illustrates an embodiment, in which a portion of the strap 1306 is adapted to engage with an aperture 1370 in the handle 1302. The handle aperture 1370 is T-shaped, being wide enough at the head end 1372 for the strap 1306 to pass through. The strap 1306 has a narrow region 1374 with lateral indentations 1376 that enable it to be locked into place within the tail end 1378 of the handle aperture 1370.

To provide a size adjustment of the gap described between the strap 1306 and the handle 1302, the handle 1302 may be provided with a plurality of apertures 1370 and 1370′ adapted to engage the strap 1306, as is illustrated in FIG. 13B. Alternatively, or additionally, the strap 1306 may be provided with a plurality of narrow regions 1374 and 1374′, as illustrated in FIG. 13C.

FIG. 14 illustrates a further embodiment, that is similar to that of FIG. 13A, but in which a strap 1406 having a narrow region 1474 is received into a forked end 1480 of the handle 1402.

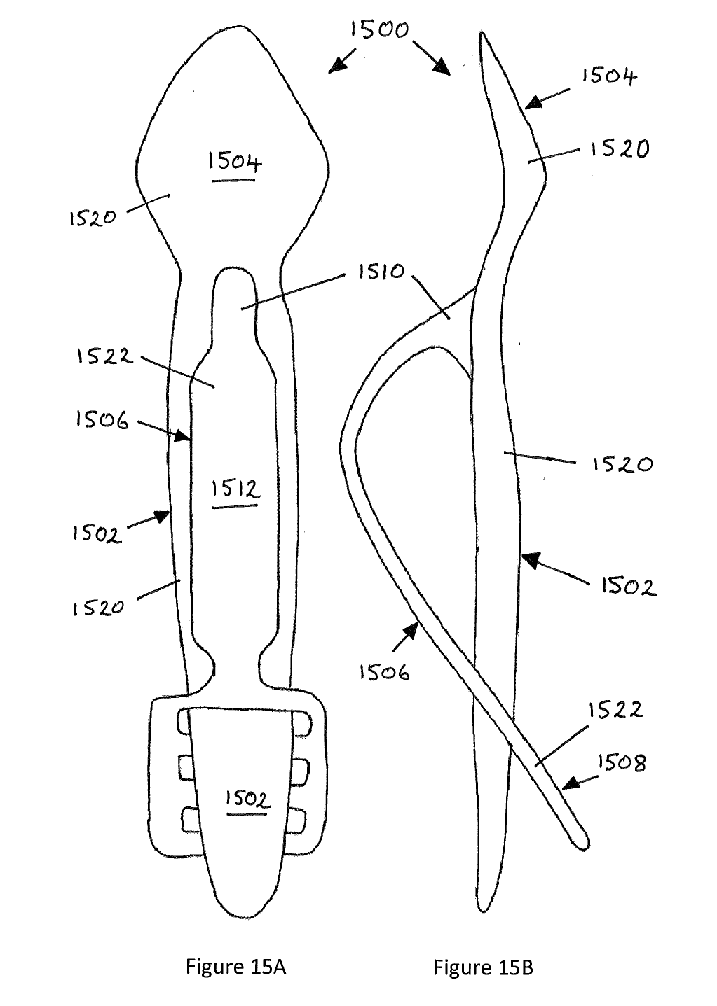

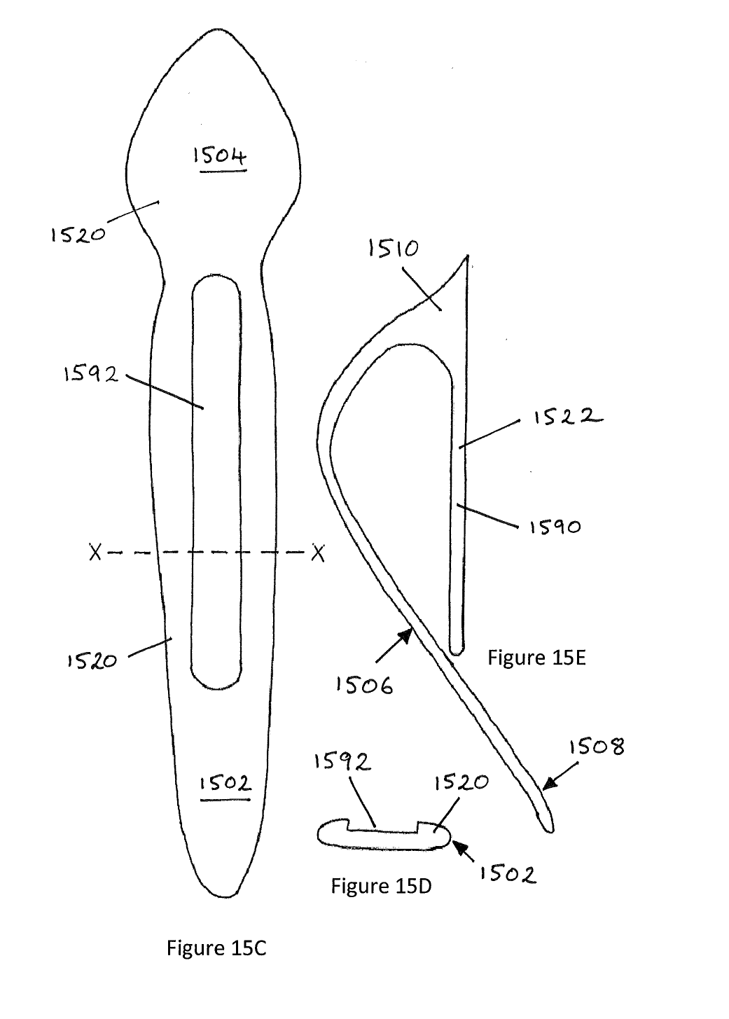

FIGS. 15A and 15B illustrate a feeding utensil 1500 according to a further embodiment. The feeding utensil 1500 of FIG. 15A differs from the feeding utensil 100 of FIG. 1A with respect to its construction. The tool end 1504 comprises the same relatively rigid first material 1520 as the handle 1502, and the strap 1506 comprises a relatively flexible second material 1522.

FIG. 15C, 15D and 15E illustrate components of the feeding utensil 1500 of FIGS. 15A and 15B. FIG. 15C illustrates the integrally formed handle 1502 and tool end 1504 component. FIG. 15D shows a cross-sectional view through the handle 1502 along the line X-X of FIG. 15C. FIG. 15E shows the strap 1502, which is formed from the second material 1522, and comprises a base 1590, which is adapted to be received into the recess 1592 in the handle 1502.

The strap 1506 of the feeding utensil component 1500 may be formed separately from the tool end 1504 and handle 1502 component, before the two pre-formed components are bonded together. Alternatively, the handle 1502 may be injection moulded onto the composite tool end 1504 and handle 1502 component as before, such that the feeding utensil is integrally formed.

The engagement section on the strap may be in a section other than the end section of the strap. For example, the strap may conveniently extend beyond the engagement section such that the free end of the strap provides a grasping feature (e.g. a tab), to facilitate engagement of the strap with the handle of the feeding utensil.

It will be appreciated that the present invention is equally applicable to a both a feeding utensil for infants and for use by older children or adults with restricted manual control or dexterity.

The figures provided herein are schematic and not to scale.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A feeding utensil having a handle, a tool end and an integrally formed flexible elongate strap, and the strap having a fixed end, a free end and an engagement section suitable for engaging with a portion of the handle.

2. A feeding utensil according to claim 1, wherein the strap is resiliently deformable.

3. A feeding utensil according to claim 1 or 2, wherein the strap comprises elastic polymeric material.

4. A feeding utensil according to claim 1, 2 or 3, wherein the handle comprises a rigid material.

5. A feeding utensil according to claim 4, wherein the rigid material is a plastics material.

6. A feeding utensil according to any preceding claim, wherein the fixed end of the strap is fixed to the handle proximate the tool end.

7. A feeding utensil according to any preceding claim, wherein the engagement section is an aperture suitable for receiving a portion of the handle.

8. A feeding utensil according to claim 7, wherein the aperture is distensible.

9. A feeding utensil according to claim 7 or 8, wherein the aperture is elongate.

10. A feeding utensil according to claim 9, wherein the direction of elongation of the aperture is transverse to the direction of elongation of the strap.

11. A feeding utensil according to claim 9, wherein the direction of elongation of the aperture is substantially perpendicular to the direction of elongation of the strap.

12. A feeding utensil according to any one of claims 7 to 11, wherein the aperture is selected from the group consisting of a straight slot, a curved slot, an oval, and a dumbbell shape.

13. A feeding utensil according to any one of claims 5 to 12, wherein the strap has a plurality of apertures suitable for receiving a portion of the handle.

14. A feeding utensil according to claim 9, wherein the strap comprises apertures of different sizes.

15. A feeding utensil according to any one of claims 7 to 14, wherein the strap comprises a strip section and a connectable section having an aperture, and the strap has a narrow region between the connectable section and the strip section.

16. A feeding utensil according to any one of claims 7 to 15, wherein the strap comprises a strip section and a connectable section comprising a plurality of apertures, and the connectable section of the strap has a narrow region between the adjacent apertures.

17. A feeding utensil according to any one of claims 7 to 16, wherein the apertures are between 10 and 16 mm long.

18. A feeding utensil according to any one of claims 7 to 17, according to any preceding claim, wherein the engagement section is an aperture suitable for receiving a portion of the handle and the aperture may be between 2 and 6 mm wide.

19. A feeding utensil according to any one of claims 1 to 6, wherein the handle and strap are provided with complementarily shaped features configured for mutual engagement.

20. A feeding utensil according to claim 19, wherein the complementarily shaped features are parts of a press-stud arrangement.

21. A feeding utensil according to claim 19, wherein the complementarily shaped features comprise, a forked end of the handle or a slot in the handle, and a narrow region of the strap configured to engage with the forked end of the handle or the slot in the handle.

22. A feeding utensil according to any preceding claim, wherein the strap comprises a strip section and a narrow fixed end section, the narrow fixed end section being between the strip section and the handle and/or tool end.

23. A feeding utensil according to any preceding claim, wherein the strap comprises a strip section and a connectable section, and the strip section and the connectable section are of substantially equal width.

24. A feeding utensil according to any one of claims 1 to 22, wherein the strap comprises a strip section and a connectable section, and the connectable section is wider than the strip section.

25. A feeding utensil according to any preceding claim, wherein the strip section has a substantially uniform width.

26. A feeding utensil according to any one of claims 1 to 24, wherein the strap comprises a strip section and a connectable section, and the strip section has a region between the ends of the strip section that is wider than the ends of the strip section.

27. A feeding utensil according to any preceding claim, wherein the strip section is substantially straight.

28. A feeding utensil according to any one of claims 1 to 26, wherein the strip section is curved.

29. A feeding utensil according to any preceding claim, wherein the strap comprises a strip section and a connectable section, and the connectable section is of a greater thickness than the strip section.

30. A feeding utensil according to any one of claims 1 to 28, wherein the strap has a substantially uniform thickness.

31. A feeding utensil according to any preceding claim, wherein a surface of the strap for contacting a user's hand has a fabric covering.

32. A feeding utensil according to any preceding claim, wherein a surface of the strap for contacting a user's hand has a friction enhancing profile.

33. A feeding utensil according to any preceding claim, wherein the strap is between 80 and 220 mm long.

34. A feeding utensil according to any preceding claim, wherein the strip is between 10 and 30 mm wide.

35. A feeding utensil according to any preceding claim, wherein the strip is between 1 and 4 mm thick.

36. A feeding utensil according to any preceding claim, wherein the engagement section is adjacent the free end of the strap.

37. A feeding utensil according to any preceding claim, wherein the engagement section is intermediate the free end and the fixed end of the strap.

38. A feeding utensil according to any preceding claim, wherein the feeding utensil is selected from the group consisting of a knife, a fork and a spoon.

39. A feeding utensil according to any preceding claim, wherein the handle comprises a first material, and the strap and tool end comprise a second material, wherein the second material is different from the first material.

40. A feeding utensil according to any preceding claim, wherein the handle and tool end comprise a first material, and the strap comprises a second material, wherein the second material is different from the first material.

41. A feeding utensil according to claim 40, wherein the handle is provide with a recess in the first material, and the strap is received into the recess.

42. A method of manufacturing a feeding utensil having a handle, a tool end and a flexible elongate strap, and the strap having a free end and a fixed end and an engagement section suitable for engaging with a portion of the handle, comprising providing handle or a portion of the handle, and integrally forming at least the strap onto the handle or portion of the handle by an injection moulding process.

43. A method of manufacturing a feeding utensil having a handle, a tool end and a flexible elongate strap, and the strap having a free end and a fixed end and an engagement section suitable for engaging with a portion of the handle, comprising providing handle or a portion of the handle, and bonding at least the strap onto the handle.

44. A feeding utensil substantially as hereinbefore described with reference to the accompanying description and any one of the Figures.

45. A method of manufacturing a feeding utensil substantially as hereinbefore described with reference to the accompanying description and any one of the Figures.
